(19) United States
(12) Patent Application Publication
(10) Pub. No.: US 2009/0283727 A1
(43) Pub. Date: Nov. 19, 2009

(54) DISKS FOR DATA STORAGE

(75) Inventors: Andrew Shipway, Jerusalem (IL); Ortal Alpert, Jerusalem (IL); Yair Salomon, Jerusalem (IL); Moshe Greenwald, Tel-Aviv (IL); Ariel Litwak, Ramat Hasharon (IL)

Correspondence Address: BROWDY AND NEIMARK, P.L.L.C.;624 NINTH STREET, NW, SUITE 300, WASHINGTON, DC, 20001-5303, US

(73) Assignee: Mempile Inc. c/o PHS Corporate Services, Inc., Wilmington, DE (US)

(21) Appl. No.: 11/813,846

(22) PCT Filed: Jan. 12, 2006
(86) PCT No.: PCT/IL06/00051

§ 371 Date: Jul. 12, 2007

Related U.S. Application Data
(60) Provisional application No. 60/643,112, filed on Jan. 12, 2005.
(60) Provisional application No. 60/696,811, filed on Jul. 7, 2005.

(51) Int. Cl. G02B 5/23; C08F 22/30

(52) U.S. Cl. 252/586; 526/298

(57) ABSTRACT

Cooperativity between groups within a polymeric photochromic medium provides the basis for enhanced writing effect. The cooperatively may be among photochromic groups being present in a high concentration.

### FIELD OF THE INVENTION

This invention relates to methods for improving writing and reading in a 3-dimensional optical memory.

### BACKGROUND OF THE INVENTION

In 3D bitwise optical storage, the volume of a medium is used to store data. In the reading of data, each point in three dimensions can be addressed individually to give a signal depending on its state as disclosed in U.S. Pat. No. 5,268,862, WO99/23650 and US2005/0078591A1. For optical storage technologies review see Burr, SPIE Conference on Nano- and Micro-Optics for Information Systems Aug. 4, 2003 Paper 5225-16. This signal is very small because of the size of the voxel itself, and in the case that this signal is fluorescent, it is also radiated equally in all directions, leading to signal that can not be collected in its entirety. It is therefore important to maximize the active chromophore concentration in the media, since this will increase substantially the signal generated by the media.

A 3-dimensional memory apparatus employing various substituted stilbenes as the active medium was disclosed in WO 03/070689. The active medium is irradiated for writing the data where the reading is done by measuring the fluorescence. Unfortunately, fluorescent dyes tend to be highly insoluble materials as a consequence of their large conjugated systems and the fact that many fluorescent dyes are ionic compounds. As a consequence, formulations for disk production, and disks themselves, can be unstable with respect to phase separation and crystallization of the dye material resulting in non-uniform disks. Some solubility enhancement can be achieved by the choice of appropriate counter-ions, the addition of solubilizing substituents to the molecular structure, and the appropriate engineering of the media matrix. However, a disk medium comprising very high concentrations of chromophores which will retain its necessary optical properties and lifetime are extremely difficult to obtain.

3D data storage solutions also suffer from problems relating to the formation of the data patterns within them. The nonlinear optical processes that are used to transform unwritten points in the media to written points require high laser powers that make commercialization difficult, and the fact that data is written by light limits its resolution and therefore the data density and indirectly the transfer rate (since there is a limit to the rate at which a disk may be spun). Another drawback of photochromic media is the destructive reading. This effect is essentially a small amount of “writing” that occurs every time a data point is read. Consequently, after a limited number of read cycles the data may become effectively erased.

### SUMMARY OF THE INVENTION

In accordance with the invention optical data media with high concentration of chromophore and in particular active chromophore are provided. Such media facilitate enhanced writing of data, as will be further explained below. Cooperativity between different active groups within the photochromic medium, whereby one light-activated group enhances the reactivity to light of another, adjacent group, may play a role and provide the basis for the enhanced writing effect. Preferred chromophores for flouoresenctic optical memory (namely such in which the data is read by measuring fluoresce light emission from the activated groups), are such in which there is minimal overlap between the spectrum of absorption and the spectrum of fluorescence.

Methods for enhancing the write ability in a photochromic medium are provided. Also provided are modified photochromic media useful for storing data. The method for enhancing light-induced conversion of an active photochromic group from one state to another in a polymer-based photochromic medium comprises providing conditions permitting cooperativity between chemical groups in said medium.

By one embodiment of the invention there is thus provided a method for producing a polymer-based photochromic medium with an enhanced light-induced conversion of an active photochromic group from one state to another, the method comprising polymerizing the medium under conditions yielding a high concentration of the active photochromic group in said medium.

Also provided by the invention is a method for enhancing the light-induced conversion of an active photochromic group from one state to another in a polymer-based photochromic medium, comprising providing a medium having a high concentration of the active photochromic group.

A particular embodiment is the enhancement of data inscription in a 3-dimensional optical memory.

An important consideration for efficient fluorescent reading at high chromophore concentration in a chromophoric medium of the present invention is reduction of the absorbance-emission overlap. Thus, the Stokes shift, namely the difference between the peak of the absorbance spectrum and the peak of emission spectra should be relatively large and/or one or both of the breadths of the two peaks should be narrow. The overlap between the absorbance-emission spectra of the chromophore should be substantially less than 70% for multilayer optical storage, preferably less than 50%, at times less than 35% and most preferably less than 20%.

Also provided by the invention are polymer-based photochromic media prepared or provided as defined above. Further provided are three-dimensional storage media comprising said polymer-based photochromic media.

The term “polymer-based photochromic medium” denotes a polymeric medium that comprises photochromic groups that can change their state from one state to another upon electromagnetic irradiation at an appropriate wavelength, e.g. an irradiation of ultraviolet (UV), visible or near infrared (IR) light. The change of state may be a switch between cis and trans configurations, between spiropyran and merocyanine forms, between the “open” and “closed” forms of diarylethenes and fulgides, between the two forms of phenoxynaphthacene quinines or a change in orientation e.g. in azobenzenes, that leads to a change in reactivity or the locality to irradiation. In a polymer-based photochromic medium marks may be inscribed that differ in their optical interaction in unmarked regions. The dimensions of the marks are usually dictated by the ability to focus light and are typically wavelength or subwavelength dimensions so as are the localities of interest in photochromic media. A polymer-based photochromic medium may be prepared by polymerization of monomers with a photochromic moiety (photochromic monomers) or co-polymerization of photochromic monomers and non-photochromic monomers, as will be detailed further below. The polymer may be of different kinds. A preferred polymer is an acrylic polymer.

The term “enhanced light-induced conversion” denotes a light-induced change in the state of the photochromic group that either occurs at a faster rate, requires less light irradiation pulses or shorter pulses or requires a lower light flux than without enhancement.

The term “photochromic group” at times referred to also as “active chromophore” denotes a group that can undergo an electromagnetic irradiation-induced change leading to a change of state of a locality of a photochromic medium from a non-mark to a written marked location or vise versa, in a manner as defined above. An active chromophore is a chromophore that is reactive to electromagnetic irradiation, typically but not exclusively in the UV, visible or near infrared light, such that it is capable of changing its state. An active chromophore has at least two states and switches from one state to another at a one wavelength different than the switch back or a switch to a further state. In the case of an optical storage medium, the concentration ratio between the two states, e.g. between a first and a second isomeric form in a given very small volume portion may represent a data unit. Reading of the data may be performed through measurement of an optical response that is different for different states of the active chromophore, such optical response may be light scattering or fluorescence at given three-dimensional location of the medium.

The term “high concentration” refers to a concentration greater than 5% (wt %), preferably greater than 10, 20%, 30%, 40% or even 50%, most preferably above 60%, at times above 70%, desirably above 80% and most desirably above 90%. These wt % concentration are calculated on the basis of the overall weight of the monomers with a photochromic moiety versus the entire weight of monomers in the medium.

The term “Cooperative effect” refers to an effect by which a non-linear positive increase in writing sensitivity is caused by an increase of the concentration of the active chromophore.

Uniquely in accordance with an embodiment of the invention, a photochromic medium having a concentration of the active chromophore substantially higher than concentration obtained in prior art media is provided. The active chromophore may be homogeneously distributed throughout the medium such that the concentration of the active chromophore in each volume unit is substantially the same. Alternatively, the modified photochromic medium may be a non homogeneous medium comprising localities of higher concentration of active chromophore separated by regions of lower concentration of active chromophore or regions that do not contain a photochromic substance. Such media may be prepared by the methods described below and referred to as “nano-particles” and “partial solvatation”. The important requirement from said chemical heterogeneity is that the scale of the heterogeneity features will be significantly smaller than the wavelengths of the interrogating/interacting light. When this requirement is met the chemically heterogeneous medium is optically homogeneous and the light passing through the medium does not suffer aberrations by the chemical heterogeneity.

The use of very high concentrations of chromophores in a photochromic medium which may be part of a 3-dimensional (3D) optical memory may be advantageous for the data reading and writing characteristics of the medium. These advantages likely arise out of the higher number of active chromophores in the focus point from which signal is emitted and of the cooperative effects between neighboring photochromic groups.

Thus, the present invention is directed to an improved photochromic medium, particularly, but not exclusively, such intended for data storage, said medium comprising a supporting polymeric substance and an active chromophore bound to the supporting substance. The photochromic medium according to one embodiment being characterized in that the active chromophore is included in the polymeric substance at a weight percent concentration greater than 5% (wt %), preferably greater than 10, 20%, 30%, 40% or even 50%, most preferably above 60%, at times above 70%, desirably above 80% and most desirably above 90%.

The photochromic medium according to another embodiment is characterized in that the polymeric substance comprises a non-active additive altering the microenvironment of the active chromophore.

The polymeric material is typically an essentially transparent medium. The essential transparency means that a substantial portion of the electromagnetic irradiation will penetrate therethrough without being absorbed or scattered.

The increase in chromophore concentration may be achieved by chemically modifying the chromophore structure at locations which do not alter its chromophoric characteristics by binding it to polymerizable monomeric moieties. In this way a modified monomer is produced and by polymerizing such modified monomers or by co-polymerizing these modified monomers with other monomers, a polymer is produced in which the photochromic groups are linked to the polymeric matrix, either pending or in the polymeric backbone. By an embodiment of the invention, the polymer is a homopolymer comprised of polymerizable active chromophore monomer. Further increase in concentration of the chromophoric group may be achieved through the use of different modified monomers, each with slightly different solubility characteristics in a monomeric solution. The total concentration of the basic chromophoric moiety in the photochromic medium is then the sum of the concentrations of the somewhat different compounds all having the identical basic chromophoric moiety.

Preferably, the polymer is a polymethylmethacylate based polymer wherein the active chromophoric groups are stilbene derivatives of the following formula (I):

Ar¹C(R¹)═C(R²)Ar² (I)

wherein Ar¹ and Ar² are phenyl groups optionally independently substituted with one or more groups selected from —C₁₋₆alkyls, —OC₁₋₆alkyl, —SC₁₋₆alkyl and, —C₁₋₆ OH, thiols and their salts, NR′R″, R′ and R″ being independently hydrogen or C₁₋₆alkyl; R¹ and R² are substituents selected from nitrites selected from —(CH₂)ₙCN, n being 0, 1 or 2, halides, carboxylic acids, their esters, or a nitro compound selected from —(CH₂)ₙNO₂, n being 0, 1 or 2.

C₁₋₆alkyls may be straight or branched alkyls, preferably a methyl, ethyl, propyl, isopropyl, butyl, sec-butyl or tert-butyl as well as pentyl groups; the nitrile is preferably a —CN group and the nitro compound is preferably an —NO₂ group.

A polymerizable active chromophore monomer useful in accordance with the invention is preferably a compound of the following formula (II):

Ar¹C(R¹)═C(R²)Ar²−M (II)

wherein Ar¹, Ar², R¹ and R² are as defined above and M is a polymerizable monomeric moiety. Specific example of M are acrylic monomers such as methylmethacrylate (MMA) and methylacrylate (MA) derivatives or a styrene-based monomer.

Exemplary photochromic-modified monomers are those of the following formula (III):

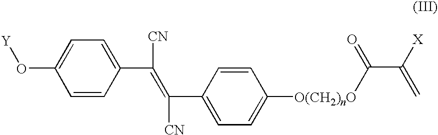

wherein X is methyl or hydrogen; n is an integer of 2 to 7; Y is hydrogen or a linear or branched alkyl moiety having 1 to 8 carbon atoms optionally substituted with halogens.

Particular examples are polymerizable active chromophore monomers of the following formula (IV) and (V) (also referred to herein as “eMMA” and “eAA”, respectively):

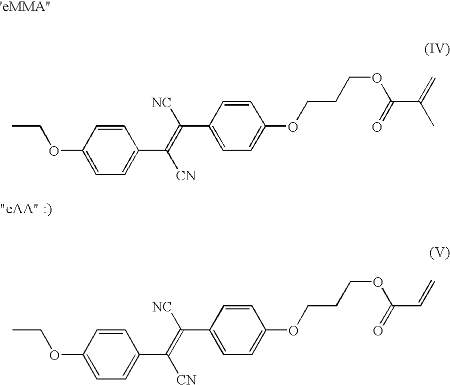

Another example is a styrene-based monomer of formula (VI):

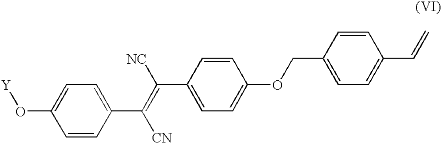

wherein Y is as defined above. A preferred Styrene derivative is that in which Y is ethyl

As already noted above, the photochromic group is preferably one with no or small absorbance-emission overlap.

The slight different Y within each compound of formula (III) enables to incorporate into the non chromophoric supporting substance a higher concentration of the basic chromophoric moiety preferably being a substituted stilbene, as already explained above.

In accordance with the present invention the active chromophore may be bonded in the non chromophoric supporting polymeric medium in a non homogeneous distribution, such that the medium comprises discrete portions of high concentration of active chromophore separated by non photochromic supporting medium. The active medium in the form of a monomeric active medium is incorporated together with a similar monomer into a different, non compatible polymer, thereby creating an interpenetrating network (IPN). In particular, the “eMMA” or “eAA” together with the appropriate monomer (the methyl esters of methacrylic acid or acrylic acid) are incorporated into polystyrene to form an interpenetrating network of “eMMA” or “eAA” within the styrene network which serves as a structural frame for the polymeric chromophore “eMMA” or “eAA”.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates the temperature dependence of the rate of “writing” in a disc made according to the present invention.

FIG. 2 illustrates the fluorescence of 4 points in an ePMMA based chromophoric medium emitted during the “writing” process at a temperature of 90° C.

FIG. 3 illustrates the fluorescence of 4 points in an ePMMA based chromophoric medium emitted during the “writing” process at a temperature of 30° C.

FIG. 4 illustrates 2D scanning of the 4 spots of FIG. 2.

FIG. 5 illustrates 2D scanning of the 4 spots of FIG. 3.

FIG. 6 illustrates a 1D scan through the 3 lower spots of FIG. 2.

FIG. 7 illustrates a 1D scan through the 3 lower spots of FIG. 3.

FIG. 8 illustrates the absorbance and emission spectra of the compound (I) of the present invention demonstrating the very small overlap between the absorbance and emission.

FIG. 9 illustrates the huge overlap between absorbance and emission in two commercial fluorescent dyes, (A) Fluorescin and (B) Rhodamine.

### DETAILED DESCRIPTION OF EXEMPLARY EMBODIMENTS

As mentioned the present invention provides a modified photochromic medium where the concentration of the active chromophore may be increased, however not necessarily in a homogeneous manner. The high concentration of the active chromophore may be 100%, i.e. the entire medium is comprised of the active chromophore. Use of very high concentrations of active chromophores in a photochromic medium is beneficial to the photochromic medium. In case the photochromic medium is part of a 3-dimensional (3D) optical memory such a high concentration gives rise to a major improvement (further to linear improvements) in data writing characteristics. The increase in the chromophore concentration is more efficient than merely an increase in the power required to write data and/or data resolution.

Without wishing to be bound by theory, when making use of the invention for storage of data, e.g. in a 3D optical memory, two phenomena appear to occur in the presence of high concentrations of excitable chromophore in a photochromic medium: accumulated thermal effect (ATE) and other chromophore cooperative effects. Together defined as cooperativity by which a non-linear positive increase in writing sensitivity is caused by an increase of the concentration of excitable chromophore. Embodiments of the invention may tale advantage of either one or both of these effects in a photochromic medium incorporating active chromophores in accordance with the invention, which may be part of a 3-dimensional (3D) optical memory. The underlining mechanism common to both ATE and other cooperative effects is a neighboring cooperative effect, where neighboring chromophores affect each other increasing the rate of writing (e.g. the rate in which the active chromophore isomerizes, under the appropriate electromagnetic irradiation, from one form to another).

The microenvironment can be fine-tuned to supplement and enhance cooperativity by designing the matrix such that the chromophores are surrounded by appropriate chemical groups that have appropriate molecular freedom of movement, and are connected to the polymer chain affecting its mobility. This may be achieved by the addition of additives and co-monomers. Such a microenvironment gives the polymer chains appropriate mobility and an appropriate polarity. Such additives are described in co-pending, co-owned application entitled “Additives and co-monomers for the enhancement of polymer properties”.

The ATE is a light-induced local heating of a material that is undergoing some kind of photochemical process. The heating does not necessarily derive from the measured photochemical process, and is usually thought of as an undesirable phenomenon. However, in the case of a photochromic media, when data is being written, the photochromic molecule undergoes photochemical excitation, absorbing energy from the incident light. The energy of the excited state of the molecule may be lost in at least one of the following three ways: (i) by fluorescence or direct energy transfer to another molecule; (ii) by chemical reaction e.g. photochromic isomerization, or (iii) by a nonradiative thermal loss of energy. All of these pathways result in some or all of the absorbed energy being converted to local thermal energy, and therefore they cause the local heating of the media. In case the incident laser pulses are long, or are temporally close together, then by excitation and re-excitation, the heating provided by the beginning of a pulse or pulse train, provides a hotter media for the latter part of the pulse or pulse train. At higher temperatures, isomerization required for writing information on the disk is improved, and the writing of data is performed more easily. Ideally the temperature increase may cause a phase change such as a glass transition melting, that dramatically increase molecular freedom. In addition, the center of the area of media addressed by the light beam receives a higher intensity of light than the outlying regions. This means that the center of the written spot receives more heating power, and therefore receives a higher enhancement than the outlying regions. In this way, the utilization of the ATE allows the inscription of data with a resolution better than can be achieved by the addressing light alone.

Turning to the other cooperative effects, these may be defined generally as effects that cause nonlinear improvements in processes as a function of concentration. Specifically in the case of a photochromic media, it can be described as an increased probability that an active chromophore will switch its state if it is spatially close to another chromophore that is undergoing switching of its own state. Most likely, a significant improvement in the probability of switching only occurs in a photochemically excited chromophore. Conceptually, the other cooperative effects can be envisaged as follows. When a photochromic molecule (chromophore) switches its state, it causes a local disturbance in the molecular-level structure of the medium. This disturbance results in stresses and free volume changes around nearby chromophores, and these effects male it easier for these additional molecules to also switch. The cooperative effect also allows the improvement of data resolution in the same way the ATE does.

The cooperative effect as described is clearly most important for chromophores that sweep out a large volume during isomerization, such as stilbenes undergoing a cis-trans isomerization, and the use of such photochromes is therefore a noted aspect of the invention. Another example of a cooperative effect occurs when energy transfer between chromophore molecules allows a single absorbance even to cause more than one chromophore to switch state, and a third example arises from the fact that high concentrations of nonlinear optical chromophores can exhibit large enhancements in their two-photon cross-sections.

The strength of both the ATE and other cooperative effects depend on three important factors: (i) the amount of photochemical excitation and its concurrency; (ii) the concentration of chromophores; (iii) the microenvironment of the chromophores. The importance of the amount of photochemical excitation may be utilized in order to achieve differentiation between the “reading” and “writing” of data in a 3D optical medium comprising the photchromophoric medium of the present invention. The “writing” is the process of irradiation resulting in the switching of a chromophore's state (e.g. cis-trans isomerization) and “reading” is the process of irradiating the “written” data (marks and spaces) and ascertaining the various states of the chromophore. That is to say, a low incident laser power is used for reading data from the disk. This low power provides only a small amount of excitation (i.e. the concentration of chromophores in excited states is low, even if the concentration of all chromophores is high), so the ATE and other cooperative effects are both minimal and thus the isomerization of chromophores is not enhanced. Alternatively, the low power may be utilized in high peak power pulses that are temporally separated so that the processes such as heat accumulation do not become significant. However, a high incident laser power and significant pulse duration are used for writing data, and under these conditions there is a large amount of excitation and re-excitation (i.e. the concentration of chromophores in excited states is high), so the ATE and cooperative effects cause a large enhancement in chromophore switching. The writing event is not necessarily limited to one pulse as long the energy transmitted to the medium is localized in space and time, thus a pulse train burst may be used, were preferably the burst duration is limited to less than a couple of hundreds of nanoseconds to minimize the spread of the writing event is space due to disk rotation and the heat diffusion period. One aspect of the invention is therefore the use of different incident laser powers for the reading and writing of data, in order to control the enhancement of chromophore switching. The concentration of the chromophore may also be utilized. When the chromophore concentration is high, the ATE and cooperative effects are both increased. A critical aspect of the invention is thus to synthesize disks that have very high concentrations of chromophores in order to achieve this enhancement. Normally, high concentrations of chromophores are not thought to be useful, since they cause problems in the excessive absorbance of signal light and for 1-photon reading or recording erasing also of addressing beam, male the synthesis of media very difficult, and can cause unwanted photochemical reactions such as self-quenching. In many cases, high concentration may yield a polymer that is too fragile, flexible or otherwise mechanically incompatible for disk manufacturing. It should be noted that the high concentration of the chromophore does not need to be uniform throughout the media, so long as the areas where the chromophore is present contain a high concentration. For example, disks may contain a nanostructure where small localities containing high concentrations of chromophore reside within regions which contains no chromophore at all thus the nanostructure may provide the required mechanical properties. Alternatively, the disk may have a micro- or macro-structure (such as a layered or skeleton structure), where only the chromophore-bearing portions are used to actively store data (WO 03/070,689). Another option is use of a fortified macro-structure as described in U.S. application Ser. No. 11/290,818.

Such a multiphase system comprising small (sub-wavelength) localities containing high concentrations of chromophore reside within regions devoid of active chromophore may be constructed in the following manner. A cross-linked polymer (hereinafter base polymer) is allowed to diffuse (swollen) by a monomer mixture comprised of chromophore-containing monomer and comonomer, e.g. eMMA, (disclosed in WO 03/070689). The monomer and the co-monomer are then polymerized and due to incompatibility with the base polymer, an interpenetrating network (IPN) would be formed (Structure and Properties of Polymeric Materials Ed. Clegg and Collyer, page 76.). The regions containing the photochromic polymer are physically and structurally reinforced by the complementing polymer. Thus polymethylmethacrylate (PMMA) and polystyrene (PS) which are well known to produce an interpenetrating network may serve as one example. Other possible non compatible polymers are PBMA or PEMA together with the chromophoric active compound eMMA incorporated into a PS matrix with a similar effect, with the benefit of enhanced writability of the chromophoric medium eMMA. Thus a cross linked disc of polystyrene may be swollen overnight with ethyl acrylate and chromophores-monomer (eMMA, eAA or other derivatives of (I)) in at least 20% wt concentration, containing an initiator (e.g. azoisobutyronitrile (BPO). All the added monomers will be absorbed by the cross linked polystyrene, and on heating, give an IPN. The IPN can also be created in different order by first creating the acryl based matrix comprising the chromophore and swelling it with styrene and then polymerizing the styrene to create the IPN, or with other polymers that form noncompatible pairs e.g. polycarbonate and PMMA, polybutyl(meth)acrylate (PBMA) or polyethyl(meth)acrylate (PEMA), or methacrylic acid ester (COPOLEX—being a mixture of benzylmethacrylate and 2,2-bis[4-(methacryloylpolyethoxy)phenyl]propane) and PMMA. Incompatibility can be created not only by the use of incompatible materials but also by the use of incompatible processes; cross-linked particles that are chromophore-acryl based only partially dissolved or not at all in MMA and therefore such particle can be used in a process that creates a mesh of one polymer that provides the photo-chemical properties and a second polymer ‘interweaved’ mesh that provides other properties while being optically compatible. Other possible photochromic media comprising non homogeneous distribution of the active chromophore may be constructed in the following two additional routes, termed as (1) Partial solvatation route and (2) nano-particles.

(1) The partial solvatation route entails:
1. Slightly cross-linked particles composed of BMA, eMMA (10% w) are synthesized, cross-linked using a mild cross-linking agent. Other examples are low percent impurities of the following compound:

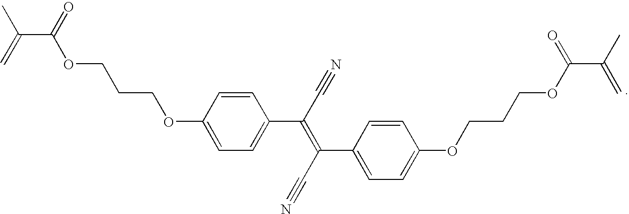

[2-Methyl-acrylic acid 3-[4-(1,2-dicyano-2-{4-[3-(2-methyl-acryloyloxy)-propoxy]-phenyl}-vinyl)-phenoxy]-propyl ester; preparation given in WO 03/070689],
other possibilities are low percent of COPLEX, or acrylate cross-linking agents such as ethylene glycol dimethacrylate.
2. The particles are mixed in styrene or MMA and partially dissolved therein
3. The styrene or MMA is polymerized, (e.g. using BPO as initiator) to create the supporting matrix. The level of the solvatation (that is controlled by the cross-linking) of the particle is such that there are no significant refractive index changes but on the other hand the cross-linking increases the level of the already existing incompatibility so as to create IPN on the micro environment level.
   (2) Use of nano-particles
1. Slightly crossed linked nano-particles composed of a copolymer of BMA and eMMA and a cross-linker are homogeneously mixed in partially polymerized MMA/PMMA/BPO mixture. The mixture is polymerized to such a degree that it does not dissolve the nano-particles.
2. Polymerization of the supporting is completed e.g. by accelerating the polymerization by raising the temperature.

The choice of monomers and polymers to create such structures and the order in which to solvatate a monomer mixture in a polymer to obtain homogeneous ‘solution’ in an intermediate step towards the formation of an IPN is known in the art and the compatibly of polymers and monomers is sometimes tabulated using solubility parameters such as Hildebrand solubility. Manufacturing of nano-particle is also known in the art (e.g. U.S. Pat. No. 6,623,761, U.S. Pat. No. 6,858,299, U.S. Pat. No. 6,966,990) and a variety is provided by different vendors

The homogeneous increase in the concentration of the chromophore according to the present invention is done by using a plurality of structures that are all functionally identical, but differ slightly in their molecular structures. For the purposes of data storage this is not a mixture, whereas for the purposes of phase separation it is a mixture since there are different compounds, slightly different in their overall structure despite the fact that they all possess an identical functional chromophoric moiety. In a mixture of compounds, each one has its own solubility limit. Therefore the mixture of structures allows a much higher total concentration of the active chromophore than a single structure, even one that is optimized for solubility, because of its much larger entropy. Even in the case that the mixture does not behave ideally, the mixture of molecular structures still gives improvements over a single structure. The mixture of functionalization that is produced at one or more places on the molecule may be optimized to provide the best possible differentiation between the molecules, while at the same time imparting other solubilizing function. In general terms, this means that the functionalization will contain a mixture of groups that have a high degree of compatibility with the matrix, are highly flexible, and have markedly differing bulk. The method of synthesis of such a mixture is also addressed. It is possible to synthesize a number of discrete compounds and then mix them to create a mixture, but this approach is not economically efficient. Instead, a mixture of functionalization is introduced to one or more points in the chromophore structure, at a suitable point in the chromophore synthesis, by the use of a mixture of reactants in a single chemical reaction, or generally by the use of a plurality of products of complex chemical reactions whose products are functionally similar or functional non disturbing.

In order to demonstrate the various concentration effects that allow the invention to improve media characteristics at high concentrations, a series of disks was synthesized. Trans-eMMA was mixed with MMA in appropriate proportions at 60° C., and 2% dilauryl peroxide was added. This mixture was filtered and cured in a mold for 24 hours to produce the samples. The samples were analyzed on a media testing apparatus which directs focused lasers into a sample of the media. The chromophore absorbs this light by 2-photon absorption, which takes place only at the focus, and undergoes photochemical processes including isomerization from the trans to the cis form and fluorescence. Isomerization represents data writing, and fluorescence represents date reading. A 671 nm solid-state laser (20 KHz, 3×15 ns pulses) was used to write data, where the inscribed data was examined by measuring the fluorescence at the same point in the media using a 658 nm pulsed laser diode. A written point was defined as a point which produced 10% less fluorescence than a previously unproved point, which is defined as modulation depth of 10%.

Table 1 lists the laser power required to create written points in a storage medium comprising of different concentrations of eMMA.

TABLE 1

| Media wt % eMMA | Required peak power to write data |
|---|---|
| 10 | 66 W |
| 15 | 49 W |
| 20 | 47 W |

This table clearly shows that high concentration of the chromophoric medium can significantly improve the writing characteristics of the media. Without ATE or other cooperative effects, there is no reason to expect different concentrations to perform differently, hence the difference in the powered required inscribing the information reflects cooperativity.

For example, each fluorescence event (absorption of 2×660 nm photons and emission of a single 500 nm photon) results in the absorption of 6×10⁻¹⁹ J, a 10 wt % eMMA disk contains 1.4×10²⁰ molecules/gr, and the heat capacity of the media is ˜1.5 degree per J/gr. Hence in case every chromophore is excited an average of once, a 10% (wt %) media is heated by ˜30° C., and a 20% media is heated by twice the amount. Given that eMMA has a 2-photon cross-section of around 250 GM, one may expect that each chromophore in the center of the diffraction limited focus point is excited several times in the above-mentioned experiments. Furthermore, at a 20 wt % concentration, most chromophores are in intimate contact with at least one other chromophore, hence there is also no doubt that the chromophores begin to interact with each other at these very high concentrations.

Another set of discs containing high concentration of eMMA together with butylmethacrylate (BMA) was prepared (according to the procedure of Example 5). The results clearly demonstrate the positive non-linear increase in write sensitivity due to high cooperativity. Table 2 displays the results of the improvement of the writing characteristics of the media (demonstrated by the decrease in power required for the writing) present in discs containing very high chromophore concentration.

TABLE 2

| | | | Pulses to write |
|---|---|---|---|
| Sample | eMMA | BMA | (4.8 W, 60 ns) |
| 82-02 | 75% | 25% | 37 |
| 84-02 | 90% | 10% | 33 |
| 82-01 | 100% | 0 | 18 |

The improvement in data writing ability employing the ATE effect may also be demonstrated indirectly by showing that temperature is a critical aspect of data writing. The results of writing data at different temperatures in a disk containing 10 wt % eMMA are presented in Table 3. In this case, pulse trains of different lengths and 30 W peak powers were used to write points in a media at different temperatures. The measurements were performed on a setup as described in U.S. application Ser. No. 11/285,210. It was found that 16 pulses at 90° C. were able to produce a more strongly written mark than 48 pulses at ambient temperature (RT).

TABLE 3

| | Power × | | |
|---|---|---|---|
| | number of | Writing | |
| Disk No. | pulses | Temperature | Max Modulation |
| *05-0042-01 | 30 × 48 | RT | 0.068 |
| 05-0042-01 | 30 × 48 | RT | 0.051 |
| 05-0042-01 | 30 × 48 | 90 | 0.108 |
| 05-0042-01 | 30 × 16 | 90 | 0.065 |
| 05-0042-01 | 30 × 16 | 90 | 0.066 |

*wt % of components: eMMA 10%; diethylphthalate 20%; MMA 70%, where to this 100% composition are added 2.5 wt % of di lauryl peroxide as an initiator for polymerization. Polymerization is done as in Example 4.

Experimental demonstration of the ability to increase the chromophore solubility was done with eMMA analogs. The analogs are designed to be easily synthesized from the synthetic precursors to eMMA. The chromophore itself is the central conjugated part of the molecule, so the ether groups may be used to introduce the solubility-enhancing functionality. If both ethers are to be used, the synthesis described in Scheme I can be used, starting from the readily available diphenol (I). The Williamson reaction of (I) with a mixture of alkyl halides leads to a mixture of a mixture of functionalized chromophores (II).

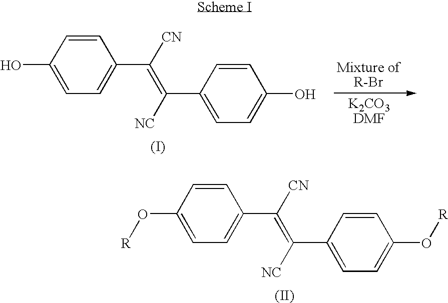

wherein R is C₁₋₆ alkyl, preferably a methyl, ethyl, propyl or butyl group.

Alternately, the solubility-enhancement of eMMA may be accomplished by modifying only the ethoxy “tail” group, so that the polymerizable acrylate group may still be used for polymerization. In this case, since only one group is utilized, a much smaller total number of compounds are generated from the same mixture of alkyl halides. An example of a method for this synthesis is given in Scheme II. The phenol (III) is reacted with the mixture of alkyl bromides by a Williamson procedure, followed by the removal of the methyl ether protecting group from the mixture of products (IV) to yield a mixture of phenols (V). This mixture is reacted with an alkylating agent containing a polymerizable group to give the final mixture of solubility-enhanced eMMA analogs (VI).

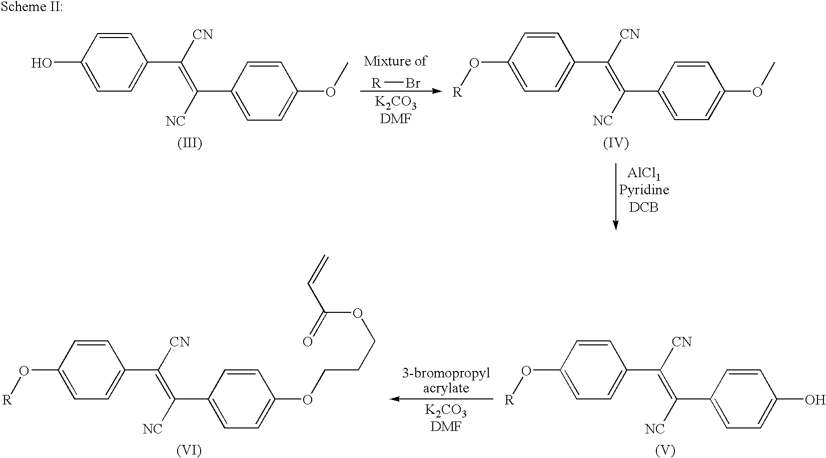

where R is as defined in Scheme I.

A third possibility for obtaining molecular structures differing in their chemical structures while maintaining the active chromophoric site would be to modify the length of the “spacer” group that connects the chromophore to the polymerizable group (3 carbon atoms in (VI). The choice of alkyl bromides that make up the mixture required for the syntheses in Schemes I and II must be made carefully, with the flowing considerations. i) The molecular size of the bromides should be limited (to 4-8 carbons), so that the average molecular weight of the products is not unnecessarily high. ii) The materials should contain branched chains, to maximize bulk. iii) Bromides with quaternary carbons should not be used, since these have very low reactivity and do not add significantly to molecular flexibility. iv) Chiral bromides are excellent choices, since they effectively consist of two materials. However, only racemic mixtures should be used unless chirality is acceptable in the final application. v) The cost of the starting materials should be low and the materials should be readily available in bulk quantities (commercial Sigma-Aldrich 2003 catalog). Table 4 demonstrates several groups used in the present invention to obtain derivatives of eMMA.

TABLE 4

| Structure | Name | Carbons | Chirality | Cost |
|---|---|---|---|---|
| 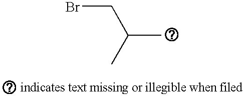 | 1-bromo-2-methy1 propane | 4 | no | ~$0.1/g |
| 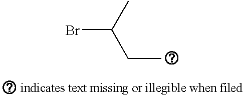 | 2-bromobutane | 4 | yes | ~$0.1/g |
| 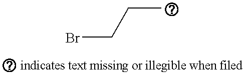 | 1-bromo-3-methyl butane | 5 | no | ~$0.1/g |
| 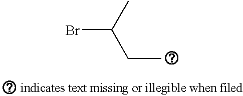 | 2-bromopentane | 5 | yes | ~$0.5/g |
| 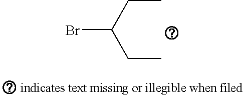 | 3-bromopentane | 5 | no | ~$1.0/g |
| 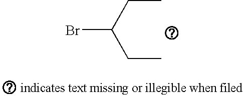 | bromocyclohexane | 6 | no | ~$0.1/g |
| 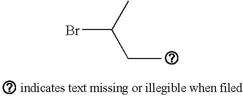 | 2-bromoheptane | 7 | yes | ~$1.0/g |
| 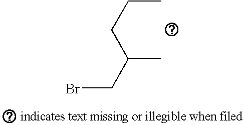 | bromomethyl cyclohexane | 7 | no | ~$1.0/g |
| 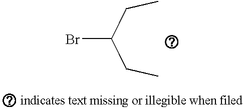 | bromocycloheptane | 7 | no | ~$1.0/g |
| 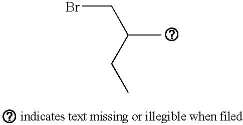 | 1-bromo-2-ethylhexane | 8 | yes | ~$0.2/g |

When carrying out the Williamson reactions with the alkyl bromide mixtures, it should be borne in mind that the different bromides have different reactivities. It is well-known that secondary halides have a reactivity of approximately an order of magnitude less than that of primary halides. This issue is addressed either by the stepwise addition of the halides to the reaction mixture, or by the use of exact stoichiometric quantities in the reaction.

A one-photon heating may be done by incorporating into the polymer matrix a certain dye which upon absorption of one photon will radiate heat to its microenvironment Such dyes are described in co-pending, co-owned application entitled “Heating Additives for Three Dimensional Optical Memory”.

The invention further describes a method to address the above problems associated with many photochromic media. A blank disk is delivered to the user in a state that is optimized for the “write” process, such that sensitive, high-yielding, and fast data writing can be achieved. After or during the writing of data, the disk (or parts thereof) is subjected to a process that in some way changes the structure of the disk from a “write-optimized” state to a “read-optimized” state. This state allows the written data to be read many times with optimized signal strength and little or no destruction of data. The switching between “read-optimized” and “write-optimized” states may be a one-way process (resulting in a “WORM” medium) or a reversible process (resulting in a potentially rewritable medium).

The derivatives of the compound of formula (I) and in particular the compound (“eMMA”) preferably used according to the present invention is photoisomerizable between trans and cis configurations. The trans configuration is characterized by (i) a much higher fluorescence than the cis; (ii) the trans configuration has a large 2-photon absorption cross-section; (iii) similar one-photon absorption. These features allow it to be used in a 3D memory, by 2-photon excitation.

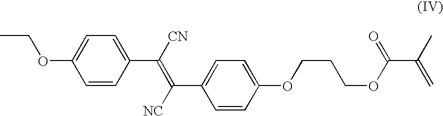

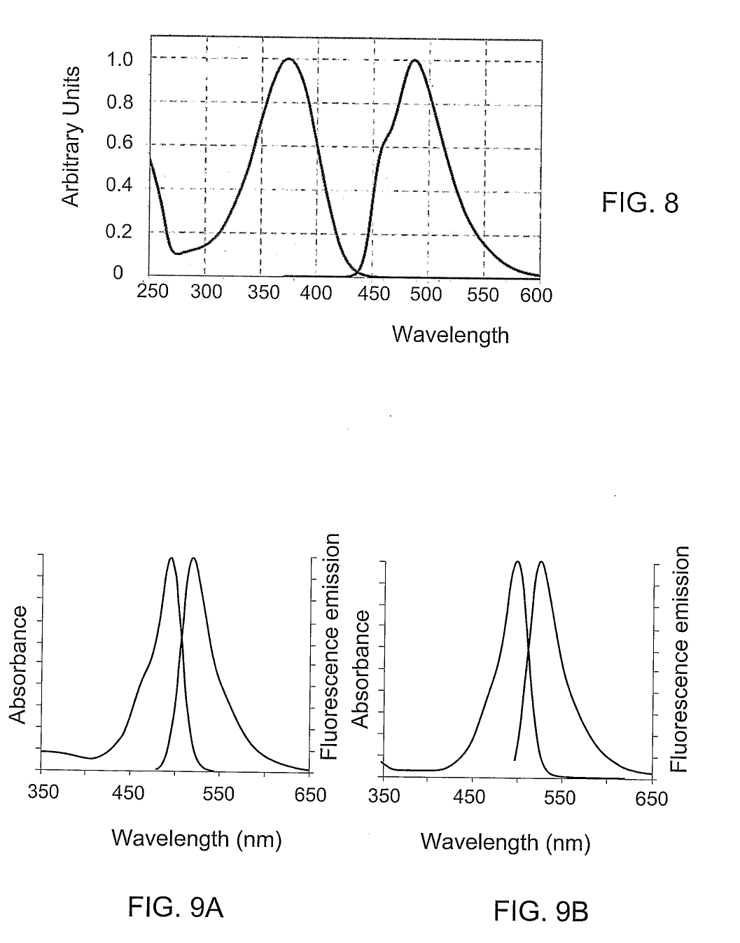

The compound (V) has a high Stokes shift of over 100 nm (FIG. 8), with very little overlap between its absorbance (maximum at 375 nm) and emission (maximum at 485 nm) spectra. This means that it may be used at a concentration of over 20 wt % in a media in accordance with the present invention before absorbance of the emission becomes a serious problem. This is in contrast with previous 3-dimensional data storage fluorescent memories, containing chromophores such as spiropyrans, diarylethenes, or phenoxynaphthacene quinones, or well-known laser dyes. These compounds all have large overlap, and thus only small concentrations of the active chromophore could be used, limiting these memories significantly in their signal strength, to the point that certain key technologies (e.g. 2-photon fluorescent readout) could not be used with them.

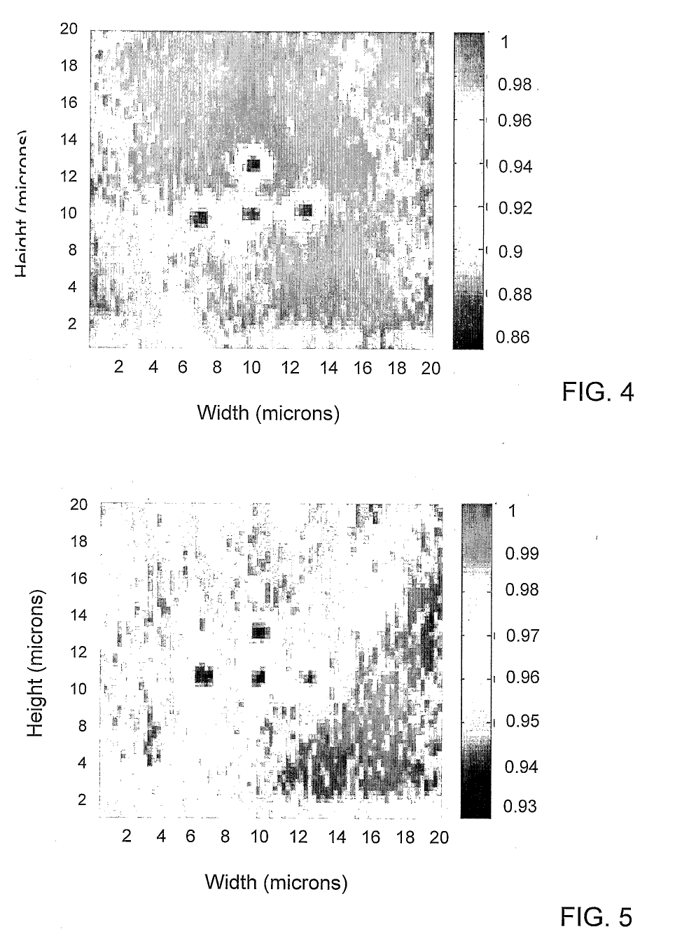

However, it should be noted that the principal point enabling efficient reading in a chromophoric medium of the present invention is not a high Stokes shift, but the reduction of the absorbance-emission overlap. It should be understood that the present invention concerns the overall overlap between the absorbance and emission spectra of the chromophore where the Stokes shift is only one of the possibilities of reducing the overlap. This overlap is defined partly by the Stokes shift and partly by the breadth of the peaks. A compound with a low Stokes shift might have excellent (small) overlap if its peaks are narrow enough, and vice versa. It should be noted that for a photochromic media, there must be low overlap between the “read” fluorescence and the absorbance spectra of both forms of the photochromic molecule. Hence, according to the present invention, absorbance-emission overlap is operatively defined as the amount of emission (in %) that is absorbed during its passage through 1 cm of a 0.01M solution of the emitting chromophore, wherein this operative definition enables the comparison of different materials. This is comparable to the loss of signal that occurs as the “read” signal escapes from a high concentration fluorescent media. In the case of the chromophores eMMA (or DMSDC), the loss is less than 10%. For most fluorophores it is considerably higher. Example spectra are given in FIG. 9 of the common fluorophores (A) fluorescein and (B) Rhodamine Green each of which have an overlap of the order of 90%. Strong overlap is also seen in other examples of fluorescent optical storage, e.g. FIGS. 4-6 in Rentzepis U.S. Pat. No. 5,268,862, FIGS. 8-9 in Levich WO99/23650 and FIG. 4 in Akselrod US2005/0078591A1. The present invention pertains to molecules with an overlap of less than ˜70%, for multilayer and 3D homogeneous optical storage, preferably less than 50%, at times less than 35% and most preferably less than 20%.

### EXAMPLES

### Example 1

Disks containing chromophores linked to a poly(acrylate) chain can be made by copolymerizing MMA with a chromophore-containing monomer, e.g. “eMMA” or “eAA” (structures below). A solution of the chromophore-containing monomer and ˜0.2% AIBN (a radical initiator) in MMA is prepared at 60-65 C, and is put into a mold in the shape of a disk. The mold is lowered into a water bath which is held at 60° C. for 18 hours, after which the mold is cooled and opened to obtain the disk.

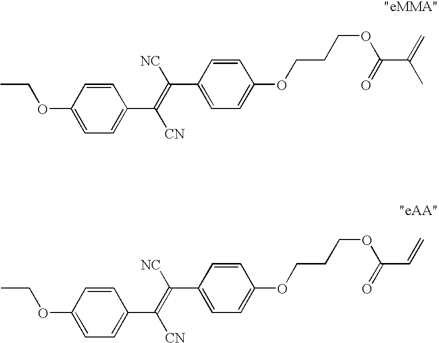

As a consequence of the solubility limit of eMMA and eAA in MMA, it is not possible to make disks that contain more than ˜20 wt % eMMA or ˜25 wt % eAA. However, it is possible to create a disk that contains both eMMA at 10 wt % and eAA at 20 wt %. Thus, by using a mixture of only two chromophore-containing molecules that differ only in a methyl group, it is possible to increase the maximum total chromophore concentration from 25 to 30 wt %. As a consequence of the solubility limit of eMMA and eAA in MMA, it is not possible to make disks that contain more than ˜20 wt % eMMA or ˜25 wt % eAA. However, it is possible to create a disk that contains both eMMA at 10 wt % and eAA at 20 wt %. Thus, by using a mixture of only two chromophore-containing molecules that differ only in a methyl group, it is possible to increase the maximum total chromophore concentration from 25 to 30 wt %.

### Example 2

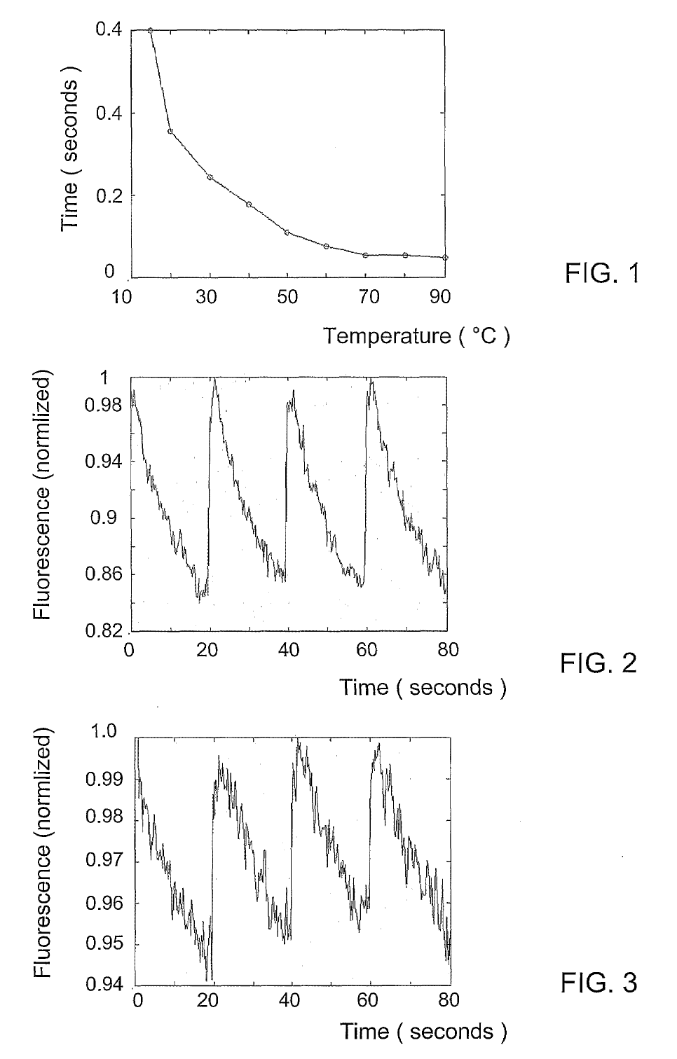

A photochromic polymer comprising eMMA as the active chromophoric medium was mounted in a temperature-controlled read/write apparatus, and data spots were written at different temperatures. The irradiation time required to write spots as a function of temperature is plotted in FIG. 1. As shown in the figure, a temperature change from 15° C. to 90° C. increases the writing speed up to tenfold, perfectly demonstrating the heating concept.

### Example 3

A photochromic polymer comprising ePMMA as the active chromophoric medium was mounted in a temperature-controlled read/write apparatus, and data spots were written at different temperatures. A difference in modulation between spots written at 90° C. and spots written at 30° C., when both are read at 30° C. were found. Spots written at 90° C. showed about twice the modulation of spots written at 30° C. Additional experiments were conducted to quantify the possible improvement factor in different polymer matrices at different temperatures.

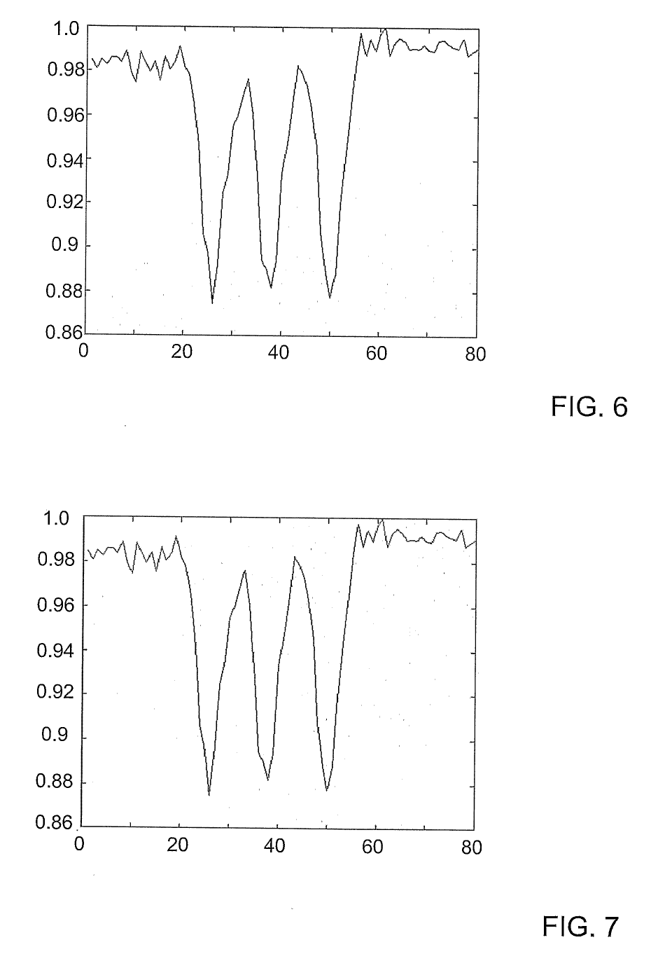

The sample was put on a copper holder that was heated using a power resistor. The holder was connected to a PI Nanocube in order to provide compensation for holder expansion during heating. A calibration cycle was done, in which the offsets resulting from expansion were measured. 4 spots were written at 90° C. Each spot was written for 20 seconds. The same pattern was written at 30° C. The reading of the written data (at 30° C. and at 90° C.) as reflected by the fluorescence was monitored and can be seen in the following FIGS. 2 (for the writing at 90° C.) and 3 (for the writing at 30° C.). As can be seen, the fluorescence at FIG. 2 is much more pronounced (0.98-0.84) than the fluorescence in FIG. 3 (0.98-0.94). The spots were scanned using the PI nanocube. The following FIGS. 4 and 5 show the results of the scans of the information written at the temperatures 90° C. and 30° C., respectively. Undoubtedly, FIG. 4 demonstrates a more clear reading reflecting a more precise writing than the writing at 30° C. A scan through the 3 lower spots can be seen in the following FIGS. 6 and 7, respectively for the reading.

### Example 4

Process for preparing PMMA based disk containing 10 wt % concentration of chromophore (eMMA)—[81.96 wt % MMA; 0.97 wt % BPO; 7.07 wt % PMMA]

A. Drying the Reactants and Preparation of Stock Solutions:

500 g of MMA is taken and to it, 20 g of Magnesium Sulfate (anhydrous) is added. A Magnetic stirring bar is put in the laboratory bottle, and the mixture is left to stir at room temperature for 30 minutes. After 30 minutes, the Mixture is filtered (using standard filtering apparatus, and kept in a sealed laboratory bottle. A stock solution of benzoylperoxide (BPO) and MMA, i.e. BPO/MMA (5% wt BPO in MMA) is prepared by taking 2.75 g of BPO (75% initiator/25% Water) and adding it to 39 g of MMA. 3 g of Magnesium Sulfate (anhydrous) and a magnetic stirring bar is added to the mixture, and the bottle is left to stir at room temperature for 30 minutes. The solution is then filtered and the subsequent solution stored in a sealed lab bottle. 20 g of PMMA (ATO VOD100) is taken and placed in a drying dish. The material is placed in a vacuum oven at 90° C. with Vacuum for 4-6 hours. Cooling should be done in the oven, with the vacuum on, and when cool, the PMMA granules should be put in a sealed lab bottle. The eMMA is generally hydrophobic, but it should be stored in a sealed bottle and prior to use can be kept in a dessicator (with either vacuum or silica gel to dry it).

90 g of the dried MMA material is taken and to it 10 g of the dried PMMA added. A magnetic stirring rod is added and the mixture is left stirring at 70° C. for 4-6 hours, (this allows the PMMA to dissolve in the MMA and gives a Polymer/Monomer stock solution.)

B. Prepolymerization:

Into a flask equipped with a magnetic stirrer are introduced 30 g of the PMMA/MMA (10% wt) stock solution, 8.2 g of the BPO/MMA (5% wt) stock solution, and 4.25 g of eMMA. The mixture is left to stir at 65° C. for 60 minutes on a hot plate while stirred allowing the eMMA to dissolve into the MMA, and initializing the polymerization process.

After 60 minutes, the material is pumped through a 5 micron Sartorius in line filter (using Argon), into pre-heated flask such that there is a minimal difference in temperature. The flask is then closed and vacuum applied for 30 seconds to 1 minute in order to degas the mixture.

C. Polymerization in Mold

The filtered and degassed mixture is poured into the pre-heated (by hot air) mold (80 mm diameter/3 mm thickness) using the open syringe and adaptor. Care should be taken when closing the gasket so as to make sure that no air bubbles enter. Once filled and closed, the molds are placed in a oven that has been pre-heated to 70° C. The polymerisation process takes about 24 hours to complete. After 24 hours at 70 C, the oven should be raised to 110° C. for 90 minutes or so. This allows full cure of the Polymer. The disks should be left to cool in the molds and if necessary, the molds can be placed in a freezer in order to ease opening them up. The obtained disk is perfectly transparent and yellow with very low internal haze.

### Example 5

Process for preparing a disc comprising 75 wt % eMMA and 25 wt % of dichlorobenzene (DLP) as an additive.

To 5 g of DLP were placed in a round bottomed flask equipped with a magnetic stirrer were added 15 g of powdered eMMA. The Round bottomed flask was placed in an oil bath and the temperature maintained at 115-120° C. After about 20-30 minutes the eMMA was fully dissolved (the DLP melted much earlier—at about 50° C. or so).

As the mixture becomes clear (i.e. completely molten), there were added into the round bottomed flask 0.2 g (1%) of DiCumyl Peroxide (DCP an initiator that has a 10 h half life of 127° C.). The DCP is a solid that melts at 38° C., and will mix into the molten eMMA/DLP immediately. After stirring for about 30 seconds in the round bottomed flask the mixture was pour mixture into a mold that has been pre-heated to 115-120° C. (the glass used in the mold should have been treated by 2% dimethyldichlorosilane in Hexane). The mold in then sealed and left overnight to polymerize. A crossedlinked disc is obtained (due to the multi-functional impurities in the eMMA).

### Examples 6-11

In a similar manner to that described in Example 5, discs containing the following ratios (wt %) between the eMMA and additive were prepared:

Example 6: 50% eMMA: 50% trichlorobenzene.

Example 7: 100% eMMA.

Example 8: 75% eMMA; 25% dichlorobenzene.

Example 9: 75% eMMA; 25% trichlorobenzene.

Example 10: 45% eMMA: 45% tricholobenzene: 10% styrene.

Example 11: 45% eMMA: 45% tricholobenzene: 10% divinylbenzene.

### Example 7

### Preparation of eAA (Acrylic acid 3-{4-[1,2-dicyano-2-(4-ethoxy-phenyl)-vinyl]-phenoxy}-propyl ester) from eMMA (2-Methyl-acrylic acid 3-{4-[1,2-dicyano-2-(4-ethoxy-phenyl)-vinyl]-phenoxy}-propyl ester) via a purified intermediate 2-(4-Ethoxy-phenyl)-3-[4-(3-hydroxy-propoxy)-phenyl]-but-2-enedinitrile

A. Synthesis of the Intermediate:

2 L reactor, was equipped with mechanical stirrer, thermometer and a dropping funnel charged with 2M KOH solution (175 cc). eMMA (75 g, 180 mmol) and acetone (1.0 L) were added and external temperature was turned on to 50° C. When mixture was completely dissolved (int. temp 45° C.) water (0.2 L) were added followed by dropwise addition of the KOH solution. The addition required 55 minutes during which time the reaction turn from yellow to orange. After additional 5 minutes reaction is quenched by pouring it into water (3.0 L) and pH was neutralized by adding water/conc. HCl solution (600 cc/12 cc). The yellow product 2-(4-Ethoxy-phenyl)-3-[4-(3-hydroxy-propoxy)-phenyl]-but-2-enedinitrile was collected by suction filtration and washed with water. 55.3 g were obtained after o.n. drying at 55° C. (94% pure, yield=83%).

B. Re-Crystallization:

EtOH (250 cc) and MeOH (750 cc) were added to obtained product (117.1 g), the mixture was heated up to ˜63° C. stirred for ˜10 minutes and filter hot. The filtrate was returned to hot plate and more EtOH (50 cc) and MeOH (420 cc) were added. To the hot and clear solution water was added slowly (830 cc, 10-15 min.)—solution became cloudy and toward the end precipitate started to accumulate. The suspension was allowed to cool slowly with stirring (1-2 hrs). When the temp reached 38° C. product was filter and washed with H₂O:MeOH 8:15 (4×150 cc). After drying (55° C., o.n.) 103.6 g of pure product (96%) were obtained. After o.n. standing additional 2.5 g were obtained from mother liquor and washings mixture (97% pure).

HPLC analysis (C18, 250×4.6, area %) 330 nm revealed the following mixture: t=3.9 (3-Cyano-2-[4-(3-hydroxy-propoxy)-phenyl]-3-(4-methoxy-phenyl)-acrylamide & 3-Cyano-3-[4-(3-hydroxy-propoxy)-phenyl]-2-(4-methoxy-phenyl)-acrylamide, 2.0%), t=5.7 (cis isomer, 2.2%), t=5.8 (trans isomer 92.1%), t=8.3 (coupling of two product compounds, 0.8%).

C. Synthesis of eAA:

A 500 cc round-bottom flask fitted with a Dean-Stark apparatus was charged with 2-(4-Ethoxy-phenyl)-3-[4-(3-hydroxy-propoxy)-phenyl]-but-2-enedinitrile (48.5 g, 139 mmol), PTSA (400 mg, 1.5% eq.), Toluene (140 cc) and acrylic acid (12.5 cc, 1.3 eq.). Reaction mixture was stirred at reflux for 12 hrs. The hot orange solution was filtered, and MeOH (300 cc) was added to the filtrate. After over-night standing at r.t. the precipitate was collected by suction filtration and washed with toluene:MeOH (1:2, 1×90 cc) and P.E. (2×90 cc). 48.2 g were obtained (˜95% pure, yield=82%). Main impurities are the stating material (1.7%) and coupling of two product compounds as in (A)(2.1%).

D. Final Purification of eAA:

eAA (108.8 g) was dissolved in hot chloroform (350 cc). Solution was cooled to r.t. and P.E. 40-60 (440 cc) was added till cloudiness appeared. The solution was passed through a short silica column (70-230 mesh, 32.5 g, 20 cm height). 91 g of eAA were obtained after evaporation in sufficient quality. Column was washed with P.E.: CHCl₃ (40:25, 195 cc) to yield additional 10.4 g, with same quality.

HPLC analysis (C18, 250×4.6, area %), 330 nm: t=6.7 (cis-eAA, 2.4%), t=6.9 (trans-eAA, 95.5%), t=7.3 (unidentified, 0.3%), t=8.3 (a mixture of 3-Cyano-2-[4-(3-hydroxy-propoxy)-phenyl]-3-(4-methoxy-phenyl)-acrylamide & 3-Cyano-3-[4-(3-hydroxy-propoxy)-phenyl]-2-(4-methoxy-phenyl)-acrylamide, 1.7%), t=8.9 (unidentified 0.1%). M.S (EI+): 402 (M⁺, 17%), 113 (CH₂═CHCOO CH₂ CH₂CH₂⁺, 100%), 85 (CH₂═CHCOOCH₂⁺, 6%).

### Example 8

### Preparation of (VI) 2-(4-Ethoxy-phenyl)-3-[4-(4-vinyl-benzyloxy)-phenyl]-but-2-enedinitrile from 2-(4-Ethoxy-phenyl)-3-(4-hydroxy-phenyl)-but-2-enedinitrile (Example 22 of WO 03/070,689)

A three-necked round-bottom flask, equipped with thermometer, was charged with 2-(4-Ethoxy-phenyl)-3-(4-hydroxy-phenyl)-but-2-enedinitrile (37 g, 127 mmol), K₂CO₃ (18.5 g, 1.05 eq.), NaI (0.86 g, 4.5% eq.), and tetrabutyl-ammonium bromide (3.7 g, 9% eq.). DMF (270 cc) was added and reaction was heated up, when reached 35° C., 4-vinylbenzylchloride ([Ald 436887, 90%], 23.7 g/21.8 cc, 1.1 eq.) was added in one portion and heating was continued until internal temperature reached 60° C. Within ½ hr the red reaction mixture became very thick and after ˜2 hrs it turned back to pale orange. After 3 hrs, water (500 cc) were added and pH was neutralized using a second portion of water/conc. HCl (250 cc/˜7.4 cc). The yellow product was collected by suction filtration and washed with water (3×135 cc), water:EtOH (1:1, 1×200 cc), EtOH (2×135 cc) and finally P.E. (2×100 cc). After o.n. drying at 55° C., 55.11 g of 4, yellow powder, were obtained (yield=99%).

If needed product may be re-crystallized from chloroform: 132 g of 4 were almost completely dissolved in reflux chloroform (˜1.5 L). Solution was filtered hot and some more chloroform (˜0.5 L) was used to dissolve clogging and precipitation on the filter paper. Hexane was added while hot (150 cc, stop when cloudiness appears), the mixture was cooled to r.t. and after ˜2 hrs standing 4 was collected.

The product has good solubility in THF, hot chloroform (˜5.5% w/w) and hot toluene (12.5% w/w). The dye exhibits an absorption peak at λ=373 nm with calculated molar absorption coefficient of ε=23300 M⁻¹ cm⁻¹.

HPLC (Alltech (apollo) C18, 250×4.6, area %), 330 nm: t=7.7 (product, 96.8%), t=7.9 (CH₂═CHPhCH₂OPhC(CN)═C(CN)Ph OCH₂PhCH═CH₂, 2.2%).

NMR (300 MHz, CDCl₃): δ 7.45, 7.39 (dd, (AB sys.), 8.9 Hz, 8.9 Hz, 4H), 7.07 (d, 9.0 Hz, 2H), 6.99 (d, 9.0 Hz, 2H), 6.73 (dd, 17.7 Hz, 10.9 Hz, 1H), 5.78 (dd, 17.7 Hz, 0.8 Hz, 1H), 5.28 (dd, 10.9 Hz, 10.9 Hz, 1H), 5.13 (s, 2H), 4.11 (q, 6.9 Hz, 2H), 1.45 (t, 6.9 Hz, 3H)

M.S (EI+): 406 (M⁺, 33%), 117 (CH₂═CHPhCH₂⁺, 100%), 91 (PhCH₂⁺, 6%).

1-24. (canceled)

25. The use of active chromophoric groups in an optical memory with a supporting polymeric medium containing active chromophoric groups and being characterized in that said chromophoric group (i) is at a concentration greater than 5% (wt %), (ii) has a minimal overlap of less than 20% between absorbance and emission spectra, and (iii) is bound to polymerizable monomeric moieties, said monomeric moieties polymerized or copolymerized with additional monomers to yield said polymer.

26. Use according to claim 25, wherein said chromophoric groups are bound to two or more different monomers.

27. Use according to claim 26, wherein said monomers comprise methylmethacrylate and methylacrylate.

28. A method for enhancing light-induced conversion of an active photochromic group from one state to another in a polymer-based photochromic medium, the method comprising:
i. use of active chromophores having (i) a concentration greater than 5% (wt %), (ii) a minimal overlap of less than 20% between absorbance and emission spectra, and (iii) being bound to polymerizable monomeric moieties, said monomeric moieties polymerized or copolymerized with additional monomers to yield said medium; and
ii. providing conditions permitting cooperativity between chemical groups in said medium.

29. A method for producing photochromic medium with an enhanced light-induced conversion of an active photochromic group from one state to another, the method comprising:
i. use of active chromophores having (i) a concentration greater than 5% (wt %), (ii) a minimal overlap of less than 20% between absorbance and emission spectra, and (iii) being bound to polymerizable monomeric moieties, said monomeric moieties polymerized or copolymerized with additional monomers to yield said medium; and
ii. polymerizing the medium under conditions yielding a high concentration of the active photochromic group in said medium.

30. A method according to claim 28, wherein said chromophoric groups are bound to two or more different monomers.

31. A method according to claim 30, wherein said monomers comprise methylmethacrylate and methylacrylate.

32. A method according to claim 28, wherein said medium further comprises a non-photochromic additive interacting with one or both of the photochromic groups and influencing their microenvironment providing enhanced light-induced conversion of the photochromic groups.

33. A photochromic medium comprising a supporting polymeric substance and an active chromophore bound to the supporting substance, being characterized in that the active chromophore is (i) included in the polymeric substance at a concentration greater than 10% (wt %), (ii) has a minimal overlap of less than 20% between absorbance and emission spectra, and (iii) bound to polymerizable monomeric moieties, said monomeric moieties polymerized or copolymerized with additional monomers to yield said polymer.

34. A medium according to claim 33, wherein said chromophoric groups are bound to two or more different monomers.

35. A medium according to claim 34, wherein said monomers comprise methylmethacrylate and methylacrylate.

36. A medium according to claim 33, comprising at least two monomeric moieties differing from one another in their solubility in a monomeric solution.

37. A medium according to claim 33, having non-linear optical properties.

38. A photochromic medium according to claim 33, wherein said active chromophore is substantially homogeneously distributed within said supporting substance.

39. A photochromic medium according to claim 33, wherein said active chromophore is substantially non-homogeneously distributed within said supporting substance.

40. A photochromic medium according to claim 39, wherein said active chromophore is distributed in discrete portions of high concentration separated by portions devoid of or having insignificant concentration of said active chromophore.

41. A photochromic medium according to claim 40, wherein said active chromophore is distributed in spaced-apart clusters each formed by said discrete portions of high concentration.

42. A photochromic medium according to claim 33, wherein the active chromophoric groups are stilbene derivatives of the following formula (I):
Ar¹C(R¹)═C(R²)Ar² (I)
wherein Ar¹ and Ar² are phenyl groups optionally independently substituted with one or more groups selected from the group consisting of —C₁₋₆alkyls, —OC₁₋₆alkyl, —SC₁₋₆alkyl and, —C₁₋₆ OH, thiols and their salts, NR′R″, R′ and R″ being independently hydrogen or C₁₋₆alkyl; R¹ and R² are substituents selected from the group consisting of nitrites selected from the group consisting of —(CH₂)ₙCN, n being 0, 1 or 2, halides, carboxylic acids, their esters, or a nitro compound selected from the group consisting of —(CH₂)ₙNO₂, n being 0, 1 or 2.

43. A photochromic medium according to claim 42, wherein the chromophoric groups are active chromophore monomer having the following formula:
Ar¹C(R¹)═C(R²)Ar²−M (II)
wherein Ar¹, Ar², R¹ and R² are as defined in claim 37 and M is a polymerizable monomeric moiety.

44. A photochromic medium according to claim 43, wherein M is an acrylic monomer.

45. A photochromic medium according to claim 43, wherein M is methylmethacrylate or methylacrylate.

46. A photochromic medium according to claim 43, wherein M is styrene.

47. A photochromic medium according to claim 42, wherein said active chromophore monomer is of the formula: 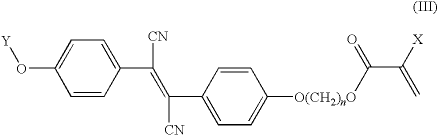
wherein X is methyl or hydrogen; n is an integer of 2 to 7; Y is hydrogen or a linear or branched alkyl moiety having 1 to 8 carbon atoms optionally substituted with halogens.

48. A photochromic medium according to claim 47, wherein said active chromophore monomer is selected from the group consisting of the formulae (IV) and (V):

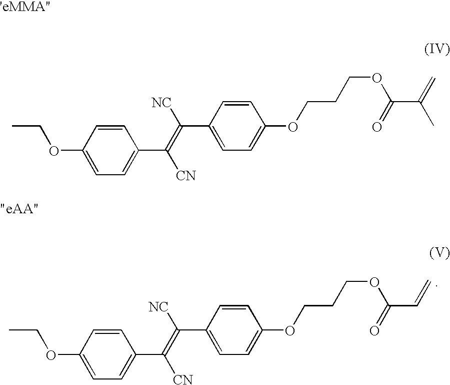

49. A photochromic medium according to claim 42, wherein said active chromophore monomer is: 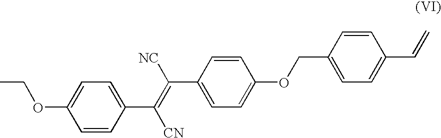
wherein Y is hydrogen or a linear or branched alkyl moiety having 1 to 9 carbon atoms optionally substituted with halogens.

50. A photochromic medium according to claim 33, wherein the chromophore has a high Stocks shift.

51. A photochromic medium according to claim 50, wherein the Stocks shift exceeds 100 nm.

52. A photochromic medium according to claim 33, wherein the concentration of the active chromophore is greater than 20%.

53. A photochromic medium according to claim 52, wherein the concentration of the active chromophore is greater than 30%.

54. A photochromic medium according to claim 53, wherein the concentration of the active chromophore is greater than 40%.

55. A photochromic medium according to claim 54, wherein the concentration of the active chromophore is greater than 50%.

56. A photochromic medium according to claim 55, wherein the concentration of the active chromophore is greater than 60%.

57. A photochromic medium according to claim 33, comprising a non-active additive altering the microenvironment of the active chromophore.
